(19) United States
(12) Patent Application Publication
(10) Pub. No.: US 2024/0354094 A1
(43) Pub. Date: Oct. 24, 2024

(54) METHOD, APPARATUS, ELECTRONIC DEVICE, STORAGE MEDIUM AND PRODUCT FOR UPDATING APPLICATION METHOD

(71) Applicant: Beijing Zitiao Network Technology Co., Ltd., Beijing (CN)

(72) Inventors: Qi Hu, Beijing (CN); Youxue Liu, Beijing (CN)

(21) Appl. No.: 18/640,910

(22) Filed: Apr. 19, 2024

(30) Foreign Application Priority Data
Apr. 21, 2023 (CN) 202310444185.4

(51) Int. Cl. G06F 8/65; G06F 11/34; G06F 11/36

(52) U.S. Cl. CPC G06F 8/65; G06F 11/3466; G06F 11/3644

(57) ABSTRACT

Embodiments of the present disclosure provide a method, an apparatus, an electronic device, a storage medium, and a product for updating an application method. The method comprises: in response to a preconfigured method tracing function is executed, obtaining a method name of a target tracing method and modifying an execution entry of the target tracing method to a tracing execution entry under a method tracing mechanism; under the method tracing mechanism, calling a preconfigured method interceptor in accordance with the method name and executing a target update method in the method interceptor, to implement update of an application method. According to the present disclosure, a new system method or a new application method may be injected during non-compilation time, making the updating of the service logic more flexible.

### CROSS-REFERENCE TO RELATED APPLICATION

This application claims priority to Chinese Application No. 202310444185.4 filed Apr. 21, 2023, the disclosure of which is incorporated herein by reference in its entity.

### FIELD

Embodiments of the present disclosure relates to the field of computer technology, and more specifically, to a method, an apparatus, an electronic device, a storage medium and a product for updating an application method.

### BACKGROUND

In case that a new service logic is injected to perform a service method update on a certain Java method in an application program at Android terminal, Aspect Oriented Programming (AOP) is usually adopted, i.e., a new service logic is injected to into the above certain Java method through modifying bytecodes during compilation of the application program.

However, if the new service logic is added through AOP, it may increase bytecodes and volume of the application program package. Besides, the system methods that do not participate the compilation of the application program package could not be modified and updated. Therefore, such method is restricted in certain aspects.

### SUMMARY

The present disclosure provides a method, an apparatus, an electronic device, a storage medium and a product for updating an application method, to intercept any Java methods and inject a new method, including service methods participating compilation of the application program and the system own methods not participating compilation of the application program. Accordingly, the updating of the application method become more flexible without increasing the volume of the application program package.

In a first aspect, embodiments of the present disclosure provide a method for updating an application method, the method comprising:
in response to a preconfigured method tracing function being executed, obtaining a method name of a target tracing method and modifying an execution entry of the target tracing method to a tracing execution entry under a method tracing mechanism; and
based on the method tracing mechanism, calling a preconfigured method interceptor in accordance with the method name and executing a targeting update method in the method interceptor, to implement update of an application method.

In a second aspect, embodiments of the present disclosure also provide an apparatus for updating an application method, the apparatus comprising:
a method execution entry changing module for in response to a preconfigured method tracing function being executed, obtaining a method name of a target tracing method and modifying an execution entry of the target tracing method to a tracing execution entry under a method tracing mechanism; and
a method interception and update module for under the method tracing mechanism, calling a preconfigured method interceptor in accordance with the method name and executing a target updating method in the method interceptor, to implement update of an application method.

In a third aspect, embodiments of the present disclosure also provide an electronic device, comprising:
one or more processors;
a storage for storing one or more programs;
when the one or more programs are executed by the one or more processors, the one or more processors are caused to implement the method for updating the application method according to any of the embodiments of the present disclosure.

In a fourth aspect, embodiments of the present disclosure also provide a storage medium containing computer executable instructions, wherein the computer executable instructions, when executed by a computer processor, perform the method for updating the application method according to any of the embodiments of the present disclosure.

In a fifth aspect, embodiments of the present disclosure further provide a computer program product including computer programs, wherein the computer programs, when executed by a processor, implement the method for updating the application method according to any of the embodiments of the present disclosure.

According to the embodiments of the present disclosure, when a preconfigured method tracing function is executed during the operation of the virtual machine in the application system, a method name of a target tracing method is obtained and an execution entry of the target tracing method is modified to a tracing execution entry under a method tracing mechanism; based on the method tracing mechanism, a preconfigured method interceptor is called in accordance with the method name and a target update method is executed in the method interceptor, to implement update of an application method. In such case, the technical solution of the embodiments of the present disclosure solves the problem in the prior art that the system method could not be modified and updated when a new method logic is injected into the application program. On the basis of the function tracing mechanism of the virtual machine, a new system method or a new application method may be injected during non-compilation time, making the service logic more novel and flexible.

### BRIEF DESCRIPTION OF THE DRAWINGS

Through the following detailed implementations with reference to the accompanying drawings, the above and other features, advantages and aspects of various embodiments of the present disclosure will become more apparent. Throughout the drawings, same or similar reference signs indicate same or similar elements. It is to be understood that the drawings are exemplary, in which original components and elements are not necessarily drawn to scale.

FIG. 1 illustrates a schematic flowchart of a method for updating an application method provided by embodiments of the present disclosure;

FIG. 2 illustrates a schematic flowchart of a method for updating an application method provided by embodiments of the present disclosure;

FIG. 3 illustrates a schematic flowchart of a method for updating an application method provided by embodiments of the present disclosure;

FIG. 4 illustrates a schematic functional framework for implementing the method for updating an application method provided by embodiments of the present disclosure;

FIG. 5 illustrates a structural diagram of an apparatus for updating an application method provided by embodiments of the present disclosure;

FIG. 6 illustrates a structural diagram of an electronic device provided by the embodiments of the present disclosure.

### DETAILED DESCRIPTION OF EMBODIMENTS

The embodiments of the present disclosure will be described in more details with reference to the drawings. Although the drawings illustrate some embodiments of the present disclosure, it should be appreciated that the present disclosure can be implemented in various manners and should not be limited to the embodiments explained herein. On the contrary, the embodiments are provided to make the present disclosure more thorough and complete. It should be appreciated that the drawings and the embodiments of the present disclosure are provided only for exemplary purpose, rather than restricting the protection scope of the present disclosure.

It is to be understood that respective steps disclosed in the method implementations of the present disclosure may be executed in different orders and/or in parallel. Besides, the method implementations may include additional steps and/or omit the demonstrated steps. The scope of the present disclosure is not restricted in this regard.

As used herein, the term “includes” and its variants are to be read as open-ended terms that mean “includes, but is not limited to.” The term “based on” is to be read as “based at least in part on.” The term “one embodiment” is to be read as “at least one embodiment.” The term “a further embodiment” is to be read as “at least a further embodiment.” The term “some embodiments” is to be read as “at least some embodiments”. Related definitions of other terms may be provided in the following description.

It is to be noted that “first” and “second” are disclosed in the present disclosure merely for distinguishing different apparatuses, modules or units, rather than restricting the sequence of the functions executed by the apparatuses, modules or units or the interdependency among the apparatuses, modules or units.

It is to be noted that the terms “one” and “more” disclosed in the present disclosure are exemplary rather than restrictive. Those skilled in the art should understand that the above terms are to be read as “one or more” unless indicated otherwise in the context.

It is to be appreciated that prior to the use of the technical solutions disclosed by various embodiments of the present disclosure, type, usage scope and application scenario of personal information involved in the present disclosure are made known to users through suitable ways in accordance with the relevant laws and regulations, to obtain user authorization.

For example, in response to receiving an active request from the users, a prompt message is sent to the users to clearly inform them that the operation requested to be executed needs to obtain and use their personal information. Accordingly, the users may voluntarily select, in accordance with the prompt message, whether to provide their personal information to software or hardware that performs operations of the technical solution, such as electronic device, application program, server or storage medium.

As an optional and non-restrictive implementation, in response to receiving an active request from the users, a prompt message is sent to the users, wherein the prompt message may be present in the form of pop-up window as an example and the prompt message may be displayed in text in the pop-up window. Besides, the pop-up window also may be provided with a select control through which the users may choose to “agree” or “disagree” the provision of personal information to the electronic device.

It should be appreciated that the above procedure for informing the users and obtaining the user authorization is only exemplary and does not restrict the implementations of the present disclosure. Other methods may also be applied to the implementations of the present disclosure as long as they comply with relevant regulations and laws.

It is to be understood that data (including but not limited to the data per se, acquisition or use of the data) involved in the technical solution should comply with corresponding laws and regulations.

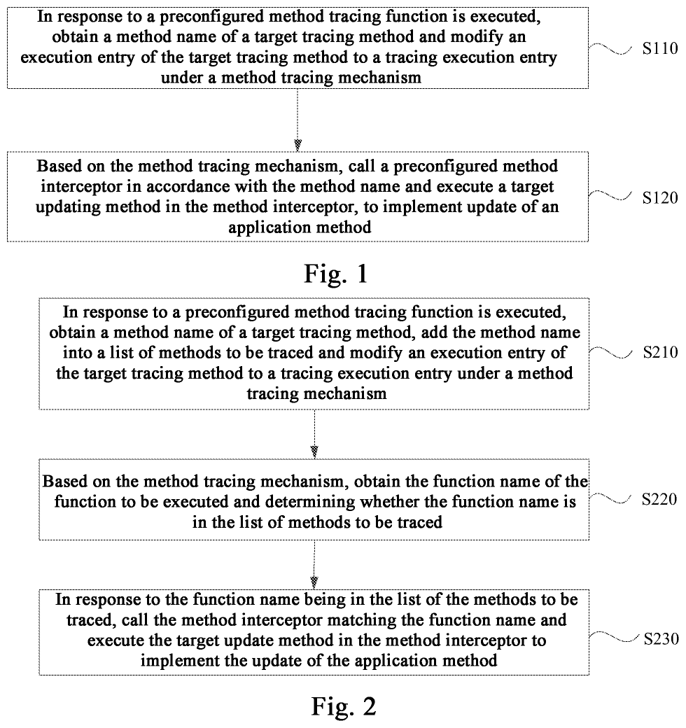

FIG. 1 illustrates a schematic flowchart of a method for updating an application method provided by embodiments of the present disclosure. The embodiments of the present disclosure are adapted to scenarios of updating service logic in application programs, especially the scenarios of updating the service logic on the basis of the function tracing mechanism of a virtual machine. Such method may be executed by an apparatus for updating an application method. The apparatus may be implemented in the form of software and/or hardware, or optionally via an electronic device, which electronic device may be a mobile terminal, a PC terminal or a server etc.

As shown in FIG. 1, the method for updating the application method includes:

S110: in response to a preconfigured method tracing function is executed, obtaining a method name of a target tracing method and modifying an execution entry of the target tracing method to a tracing execution entry under a method tracing mechanism.

Wherein the method tracing function is a function provided for tracing an execution process of a given method logic, so as to be aware of the starting and ending time for executing this method logic during the operation of the program and details of the execution procedure. Variable values passed by the function or method may be selectively displayed during the method tracing.

The method tracing function may be a method logic configured during initialization of the operating environment of the virtual machine. For example, a Software Development Kit (SDK) capable of implementing the method tracing function is loaded into the virtual machine executing the application programs through initialization process, such that the virtual machine may provide corresponding method tracing function. Developers may directly call the preconfigured method tracing function to trace a target tracing method while developing the application programs. Correspondingly, during execution of the specific service functions of the application programs, when the method tracing function is performed, the virtual machine obtains its incoming parameters. That is, a target tracing method is determined and a method name of the target tracing method is obtained.

Usually, the execution of a service method is not traced. The target tracing method may be made to be a traceable method by modifying its execution entry into a tracing execution entry under the method tracing mechanism.

Wherein the method tracing mechanism may be a built-in function tracing mechanism in the virtual machine, or a preconfigured mechanism. If the virtual machine is provided with function tracing mechanism and functions, the function tracing function may be more easily implemented. The tracing execution entry under the method tracing mechanism may be an interpretation execution entry, or events in the function tracing monitoring function class (e.g., instrumentation stub). In case that the execution entry of a function is the tracing execution entry under the method tracing mechanism, this function may serve as an object traced by the tracing function (e.g., the_trace_object in Trace class) and enter the method tracing execution phase.

S120: based on the method tracing mechanism, calling a preconfigured method interceptor in accordance with the method name and executing a target updating method in the method interceptor, to implement update of an application method.

Wherein the method interceptor is a preset interceptor in accordance with service requirements in need of an application method update. When the preconfigured method tracing function is executed, the method interceptor matching the target tracing method will be called back.

As an object called by dynamic intercepting execution action (Action), the method interceptor provides a mechanism that allows the developers to execute a segment of codes before or after the execution of one Action or prevent one Action from being executed from the beginning, while offering an approach that may extract reusable codes from the Action. In the embodiments, a method interceptor is preconfigured in view of the service needs in the actual application, and the application method to be updated is written into the method interceptor, to implement injection of a new service logic.

Specifically, calling of the method interceptor may be implemented via a “Proxy”. The “Proxy” may be understood as a layer of “interception” presumed before the execution of the target tracing function, which is implemented in the remaining configuration of the method interceptor. Upon entry of the method tracing mechanism, the method interceptor will be called back through the “Proxy” for the target tracing method, and the target update method in the method interceptor is executed to update the application method.

Since the above steps may occur at the execution phase of any application programs, any Java method may server as the method tracing method according to the service logic requirements, including service methods participating App compilation and the system's own Java methods of that do not participate the App compilation. Through the above application program update, the volume of the application program package would not be affected even if a new service logic is injected.

According to the technical solution of the embodiments of the present disclosure, when a preconfigured method tracing function is executed during the operation of the virtual machine in the application system, a method name of a target tracing method is obtained and an execution entry of the target tracing method is modified to a tracing execution entry under a method tracing mechanism; based on the method tracing mechanism, a preconfigured method interceptor is called in accordance with the method name and a target update method is executed in the method interceptor, to implement update of an application method. In such case, the technical solution of the embodiments of the present disclosure solves the problem in the prior art that the system method could not be modified and updated when a new method logic is injected into the application program. On the basis of the function tracing mechanism of the virtual machine, a new system method or a new application method may be injected during non-compilation time, making the updating of the service logic more flexible.

FIG. 2 is a schematic flowchart of a further method for updating an application method provided by the embodiments of the present disclosure. On the basis of the above embodiments, a determination as to whether to perform the method tracing is added into the implementation of the flow of the method for updating the application method. The method may be executed by an apparatus for updating an application method. The apparatus may be implemented in the form of software and/or hardware, or optionally via an electronic device, which electronic device may be a mobile terminal, a PC terminal or a server etc.

As shown in FIG. 2, the method for updating the application method comprises:

S210: in response to a preconfigured method tracing function being executed, obtaining a method name of a target tracing method, adding the method name into a list of methods to be traced and modifying an execution entry of the target tracing method to a tracing execution entry under a method tracing mechanism.

In this embodiment, the method tracing function may be a function for tracing the execution of a given method logic preconfigured on the basis of the Instrumentation function tracing mechanism of the ART virtual machine.

Wherein, for the Instrumentation function tracing mechanism, when any Java method is interpreted and executed or the entry is Instrumentation stub, the ART virtual machine will first determine whether a relevant InstrumentationListener is registered through the Instrumentation before executing the original function of the Java method. If a corresponding Listener is registered, a Method Enter event of the Listener will be called back first. The method tracing function is a preconfigured specific implementation of the InstrumentationListener, i.e., the_trace_object in class of Trace in the ART virtual machine.

When the preconfigured method tracing function is executed, its incoming parameters are obtained to acquire the method name of the target tracing method. Afterwards, the method name is added into the list of methods to be traced. The reason for this is to optimize the subsequent function tracing procedure. In addition to the function tracing being performed due to the application method update resulted from service requirements, Java in other service execution logics is also traced. However, not all traced Java methods are injected with new methods. Accordingly, it is required to label the target tracing method upon execution of the method tracing function.

The tracing execution entry under the method tracing mechanism may be the interpretation execution entry, or events in the function tracing monitoring function class (e.g., instrumentation stub). In case that the execution entry of a function is the tracing execution entry under the method tracing mechanism, the process goes to the method tracing execution phase of the function.

S220: based on the method tracing mechanism, obtaining the function name of the function to be executed, and determining whether the function name is in the list of methods to be traced.

In this step, it is required to identify the function to be executed (Java method) under the method tracing mechanism, to determine whether it is a Java method that is traced due to the need for updating the service method, thereby avoiding tracing and intercepting the non-target tracing functions.

Specifically, the determination may be made through the function name (method name) and the function name (method name) obtained during the execution is matched with the method name in the list of methods to be traced to obtain a target determination result.

At 230, in response to the function name being in the list of the methods to be traced, the method interceptor matching the function name is called and the target update method in the method interceptor is executed to implement the update of the application method.

When it is determined that the function name (method name) of the function to be executed is in the list of methods to be traced, the method interceptor matching the function name may be called through JNI (Java Native Interface) and the target update method in the method interceptor is executed to implement the update of the application method; otherwise, the tracing operation of the function is executed following the service logic of the conventional function tracing mechanism.

Wherein the target update method may be a new application method required to be injected in view of the service requirements and may be preconfigured in the method interceptor by the developers.

According to the technical solution of the embodiments of the present disclosure, when a preconfigured method tracing function is executed during the operation of the virtual machine in the application system, a method name of a target tracing method is obtained, the method name is added into the list of methods to be traced and an execution entry of the target tracing method is modified to a tracing execution entry under a method tracing mechanism; based on the method tracing mechanism, the target tracing function is determined according to the function name of the function to be executed as obtained and the preconfigured method interceptor is called according to the function name, so as to implement the target update method in the method interceptor and update the application method. In such case, the technical solution of the embodiments of the present disclosure solves the problem in the prior art that the system method could not be modified and updated when a new method logic is injected into the application program. On the basis of the function tracing mechanism of the virtual machine, a new system method or a new application method may be injected during non-compilation time, making the updating of the service logic more flexible.

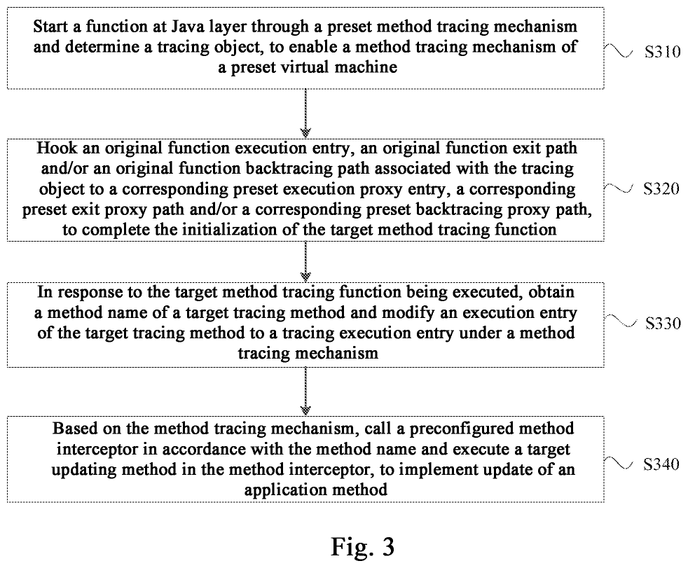

FIG. 3 is a schematic flowchart of another method for updating an application method provided by the embodiments of the present disclosure. On the basis of the above embodiments, the procedure of preconfiguring the method tracing function is further elaborated. The method may be executed by an apparatus for updating an application method. The apparatus may be implemented in the form of software and/or hardware, or optionally via an electronic device, which electronic device may be a mobile terminal, a PC terminal or a server etc.

As shown in FIG. 3, the method for updating the application method comprises:

S310: starting a function at Java layer through a preset method tracing mechanism and determining a tracing object, to enable a method tracing mechanism of a preset virtual machine.

Wherein starting the function at the Java layer through a preset method tracing mechanism and enabling the method tracing mechanism of the preset virtual machine which may be appreciated as a method tracing mechanism set for an application program programmed in Java language.

Specifically, the procedure of determining the tracing object through enabling the function via the preset method tracing mechanism may include pre-creating a tracing object on the basis of the function tracing mechanism of the virtual machine itself and implementing the method tracing mechanism based on the execution logic of Method Enter, Method Exit or Method Backtrace events for the tracing object.

As an example, when the virtual machine is an ART virtual machine, the starting a function at Java layer through a preset method tracing mechanism and determining a tracing object, to enable a method tracing mechanism of a preset virtual machine includes: first creating and registering an Instrumentation listener as the tracing object; and then setting entries of methods of all classes in Java layer as tracing execution entries through an enable method tracing function in Instrumentation. After the startup, the system will mandate all methods to set an interpretation execution entry; before calling any Java methods, it will be forwarded to Method Enter Event (Method Entered) callback of the_trace_through the function tracing mechanism of Instrumentation; and before Method Exit (return), it will be forwarded to Method Exit Event (Method Exited) callback of the_trace_through the Instrumentation mechanism. In other words, a hook is inserted before entry and exit of any methods and the injection of the service logic is implemented in the hook.

In one optional implementation, the enable method tracing function Hook in the Instrumentation may be preset as an enable method tracing proxy function (Enable Method Tracing Proxy); wherein the preset enable method tracing proxy function may be empty, i.e., each Java method is not mandated to set an interpretation execution entry. The native logic of the Enable Method Tracing may lead to tracing of methods in all classes. However, in some service scenarios, it is expected to trace specific Java methods having service logic need, and unspecified Java methods may not be subject to execution entry conversion. Therefore, the operating performance of the virtual machine is optimized and the computation resources of the virtual machine are saved. In case that the Hook is a preset enable method tracing proxy function, developers may individually configure for which methods the tracing is enabled. For the methods in need of tracing, their entry is configured as interpretation execution entry (art_quick_to_interpreter_bridge) or instrumentation stub (art_quick_instrumentation_entry).

S320: Hooking an original function execution entry, an original function exit path and/or an original function backtracing path associated with the tracing object to a corresponding preset execution proxy entry, a corresponding preset exit proxy path and/or a corresponding preset backtracing proxy path, to complete the initialization of the target method tracing function.

In this step, a “proxy (Proxy)” that may call the corresponding method interceptor is set. It is determined via the “proxy” whether the function to be executed as obtained is a function that needs to be tracked.

S330: when the target method tracing function is executed, obtaining a method name of a target tracing method and modifying an execution entry of the target tracing method to a tracing execution entry under a method tracing mechanism.

During execution of the specific service functions of the application programs, when the target method tracing function is performed, the virtual machine obtains the incoming parameters of the method tracing function. That is, a target tracing method is determined and a method name of the target tracing method is obtained.

In an optional method, during execution of any one Java method, if it is determined that the any one Java method has a self-defined corresponding listener (Listener), the any one Java method may act as the target tracing method to obtain the method name of the target tracing method.

S340: based on the method tracing mechanism, calling a preconfigured method interceptor in accordance with the method name and executing a target update method in the method interceptor, to implement update of an application method.

Calling the preconfigured method interceptor according to the method name may include: matching the corresponding preset execution proxy entry, preset exit proxy path or backtracing proxy path through the preconfigured “proxy” in accordance with the method name of the target tracing method and calling the preconfigured method interceptor corresponding to the method name. The calling procedure may be implemented based on the Java local interface. Further, the target update method in the method interceptor is executed to update the application method.

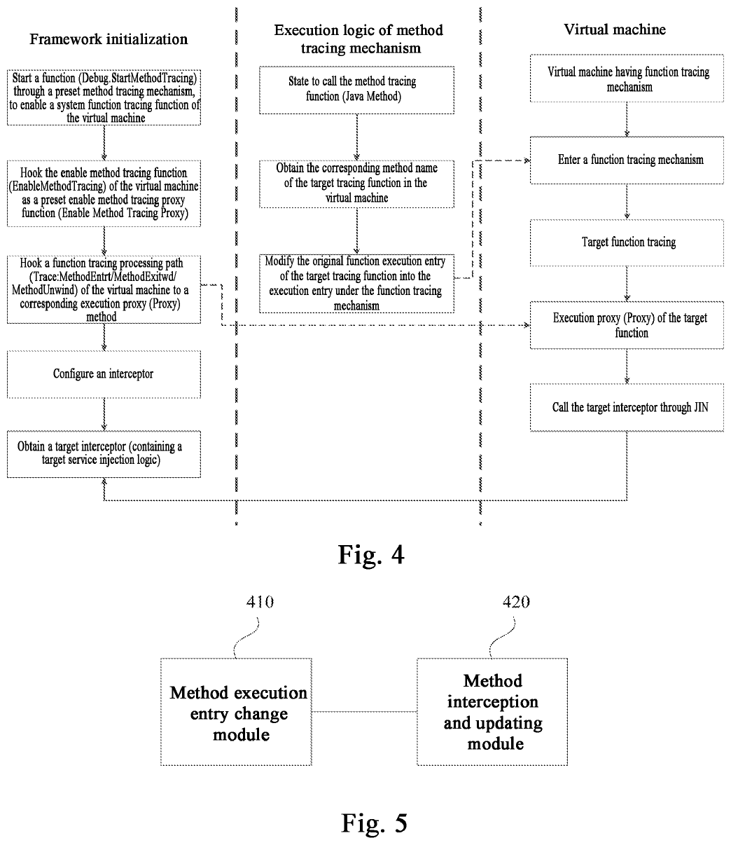

As an example, a functional framework for implementing the method for updating an application method according to the embodiments may refer to the function tracing functional framework shown in FIG. 4. In FIG. 4, the initial setup (framework initialization) of the method tracing mechanism may be performed in advance, which may be understood as addition of tool installation packages. Then, users may directly use the tool kit to trace the target function. When the virtual machine executes the corresponding method tracing function, the function tracing method will be performed according to the preconfigured tracing logic.

According to the technical solution of the embodiments of the present disclosure, the function tracing function is configured during the initialization of the application system. As such, a function is started at Java layer through a preset method tracing mechanism and a tracing object is determined, and a method tracing mechanism of a preset virtual machine is started; and an original function execution entry, an original function exit path and/or an original function backtracing path associated with the tracing object is Hooked to a corresponding preset execution proxy entry, a corresponding preset exit proxy path and/or a corresponding preset backtracing proxy path, to complete initialization of the target method tracing function. Moreover, when a preconfigured method tracing function is executed during the operation of the virtual machine in the application system, a method name of a target tracing method is obtained and an execution entry of the target tracing method is modified to a tracing execution entry under a method tracing mechanism; based on the method tracing mechanism, a preconfigured method interceptor is called in accordance with the method name and a target update method is executed in the method interceptor, to implement update of an application method. In such case, the technical solution of the embodiments of the present disclosure solves the problem in the prior art that the system method could not be modified and updated when a new method logic is injected into the application program. On the basis of the function tracing mechanism of the virtual machine, a new system method or a new application method may be injected during non-compilation time, making the service logic more novel and flexible.

FIG. 5 illustrates an apparatus for updating an application method provided by embodiments of the present disclosure. The apparatus is adapted to scenarios of updating service logic in application programs, especially the scenarios of updating the service logic on the basis of the function tracing mechanism of a virtual machine. The apparatus for updating an application method may be implemented in the form of software and/or hardware, or optionally via an electronic device, which electronic device may be a mobile terminal, a PC terminal or a server etc.

As shown in FIG. 5, the apparatus for updating an application method comprises: a method execution entry changing module 410 and a method interception and update module 420.

Wherein the method execution entry changing module 410 is used for in response to a preconfigured method tracing function being executed, obtaining a method name of a target tracing method and modifying an execution entry of the target tracing method to a tracing execution entry under a method tracing mechanism; and the method interception and updating module 420 is provided for based on the method tracing mechanism, calling a preconfigured method interceptor in accordance with the method name and executing a target update method in the method interceptor, to implement update of an application method

According to the technical solution of the embodiments of the present disclosure, when a preconfigured method tracing function is executed during the operation of the virtual machine in the application system, a method name of a target tracing method is obtained and an execution entry of the target tracing method is modified to a tracing execution entry under a method tracing mechanism; based on the method tracing mechanism, a preconfigured method interceptor is called in accordance with the method name and a target update method is executed in the method interceptor, to implement update of an application method. In such case, the technical solution of the embodiments of the present disclosure solves the problem in the prior art that the system method could not be modified and updated when a new method logic is injected into the application program. On the basis of the function tracing mechanism of the virtual machine, a new system method or a new application method may be injected during non-compilation time, making the service logic more novel and flexible.

In an optional implementation, the method execution entry changing module 410 is also provided for:
after obtaining a method name of a target tracing method, adding the method name into a list of methods to be traced.

In an optional implementation, the method interception and updating module 420 is specifically for:
determining whether a function name of a function to be executed obtained under the method tracing mechanism is in the list of methods to be traced;
when the function name is in the list of methods to be traced, calling a method interceptor matching the function name.

In an optional implementation, the apparatus for updating an application method also comprises a method tracing function configuration module for:
starting a function at Java layer through a preset method tracing mechanism and determining a tracing object, to enable a method tracing mechanism of a preset virtual machine;
Hooking an original function execution entry, an original function exit path and/or an original function backtracing path associated with the tracing object to a corresponding preset execution proxy entry, a corresponding preset exit proxy path and/or a corresponding preset backtracing proxy path.

In an optional implementation, the method tracing function configuration module is further used for:
creating and registering an Instrumentation listener as the tracing object;
setting entries of methods of all classes in Java layer as tracing execution entries through an enable method tracing function in Instrumentation.

In an optional implementation, the method tracing function configuration module may further be provided for:
Hooking the enable method tracing method as a preset enable method tracing proxy function;
wherein the preset enable method tracing proxy function is empty.

In an optional implementation, the method interception and updating module 420 is also provided for:
calling a preconfigured method interceptor matching the method name through the preset execution proxy entry, the preset exit proxy path and/or the preset backtracing proxy path based on a Java local interface.

In an optional implementation, the method execution entry changing module 410 is further provided for:
when any one Java method is executed, determining whether the any one Java method is provided with a listener;
when the any one Java method is provided with a listener, taking the any one Java method as a target tracing method and obtaining a method name of a target tracing method.

The apparatus for updating an application method provided by the embodiments of the present disclosure may execute the method for updating the application method provided by any embodiments, includes the corresponding functional modules for executing the method and achieves the advantageous effects.

It is to be noteworthy that the respective units and modules included in the above apparatus are divided only by functional logic. The units and modules may also be divided in other ways as long as they can fulfill the corresponding functions. Further, the names of the respective functional units are provided only to distinguish one from another, rather than restricting the protection scope of the embodiments of the present disclosure.

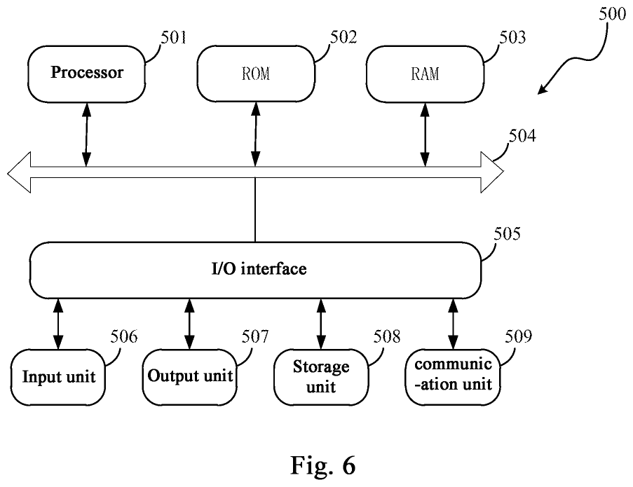

FIG. 6 illustrates a structural diagram of an electronic device provided by the embodiments of the present disclosure. With reference to FIG. 6, a structural diagram of an electronic device (e.g., terminal device or server in FIG. 6) 500 adapted to implement embodiments of the present disclosure is shown. In the embodiments of the present disclosure, the terminal device may include, but not limited to, mobile terminals, such as mobile phones, notebooks, digital broadcast receivers, PDAs (Personal Digital Assistant), PADs (tablet computer), PMPs (Portable Multimedia Player) and vehicle terminals (such as car navigation terminal) and fixed terminals, e.g., digital TVs and desktop computers etc. The electronic device shown in FIG. 6 is just an example and will not put any restrictions on the functions and application ranges of the embodiments of the present disclosure.

According to FIG. 6, the electronic device 500 may include a processor (e.g., central processor, graphic processor and the like) 501, which can execute various suitable actions and processing based on the programs stored in the read-only memory (ROM) 502 or programs loaded in the random-access memory (RAM) 503 from a storage unit 508. The RAM 503 can also store all kinds of programs and data required by the operations of the electronic device 500. Processor 501, ROM 5002 and RAM 503 are connected to each other via a bus 504. The input/output (I/O) interface 505 is also connected to the bus 504.

Usually, input unit 506 (including touch screen, touchpad, keyboard, mouse, camera, microphone, accelerometer, gyroscope and like) and output unit 507 (including liquid crystal display (LCD), speaker and vibrator etc.), storage unit 508 (including tape and hard disk etc.) and communication unit 509 may be connected to the I/O interface 505. The communication unit 509 may allow the electronic device 500 to exchange data with other devices through wired or wireless communications. Although FIG. 6 illustrates the electronic device 500 having various units, it is to be understood that it is not a prerequisite to implement or provide all illustrated units. Alternatively, more or less units may be implemented or provided.

In particular, in accordance with embodiments of the present disclosure, the process depicted above with reference to the flowchart may be implemented as computer software programs. For example, the embodiments of the present disclosure include a computer program product including computer programs carried on a non-transient computer readable medium, wherein the computer programs include program codes for executing the method demonstrated by the flowchart. In these embodiments, the computer programs may be loaded and installed from networks via the communication unit 509, or installed from the storage unit 508, or installed from the ROM 502. The computer programs, when executed by the processor 501, performs the above functions defined in the method for video editing according to the embodiments of the present disclosure.

Names of the messages or information exchanged between a plurality of apparatuses in the implementations of the present disclosure are provided only for explanatory purpose, rather than restricting the scope of the messages or information.

The electronic device provided by the embodiments of the present disclosure and the application method updating method according to the above embodiments belong to the same inventive concept. The technical details not elaborated in these embodiments may refer to the above embodiments. Besides, these embodiments and the above embodiments achieve the same advantageous effects.

Embodiments of the present disclosure also provide a computer storage medium on which computer programs are stored, which programs when executed by a processor implement the application method updating method provided by the above embodiments.

It is to be explained the above disclosed computer readable medium may be computer readable signal medium or computer readable storage medium or any combinations thereof. The computer readable storage medium for example may include, but not limited to, electric, magnetic, optical, electromagnetic, infrared or semiconductor systems, apparatus or devices or any combinations thereof. Specific examples of the computer readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof. In the present disclosure, the computer readable storage medium may be any tangible medium that contains or stores programs. The programs may be utilized by instruction execution systems, apparatuses or devices in combination with the same. In the present disclosure, the computer readable signal medium may include a data signal propagated in baseband or as part of a carrier wave, carrying computer readable program codes therein. Such propagated data signals may take many forms, including but not limited to, electromagnetic signals, optical signals, or any suitable combinations thereof. The computer readable signal medium may also be any computer readable medium in addition to the computer readable storage medium. The computer readable signal medium may send, propagate, or transmit programs for use by or in connection with instruction execution systems, apparatuses or devices. Program codes contained on the computer readable medium may be transmitted by any suitable media, including but not limited to: electric wires, fiber optic cables and RF (radio frequency) etc., or any suitable combinations thereof.

In some implementations, clients and servers may communicate with each other via any currently known or to be developed network protocols, such as HTTP (HyperText Transfer Protocol) and interconnect with digital data communications in any forms or media (such as communication networks). Examples of the communication networks include Local Area Network (LAN), Wide Area Network (WAN), internet work (e.g., Internet) and end-to-end network (such as ad hoc end-to-end network), and any currently known or to be developed networks.

The above computer readable medium may be included in the aforementioned electronic device or stand-alone without fitting into the electronic device.

The above computer readable medium bears one or more programs. When the above one or more programs are executed by the electronic device, the electronic device is enabled to:
when a preconfigured method tracing function is executed, obtain a method name of a target tracing method and modify an execution entry of the target tracing method to a tracing execution entry under a method tracing mechanism;
based on the method tracing mechanism, call a preconfigured method interceptor in accordance with the method name and execute a target update method in the method interceptor, to implement update of an application method.

Computer program instructions for executing operations of the present disclosure may be written in one or more programming languages or combinations thereof. The above programming languages include, but not limited to, object-oriented programming languages, e.g., Java, Smalltalk, C++ and so on, and traditional procedural programming languages, such as “C” language or similar programming languages. The program codes can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider).

The flow chart and block diagram in the drawings illustrate system architecture, functions and operations that may be implemented by system, method and computer program product according to various implementations of the present disclosure. In this regard, each block in the flow chart or block diagram can represent a module, a part of program segment or code, wherein the module and the part of program segment or code include one or more executable instruction for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Units described in the embodiments of the present disclosure may be implemented by software or hardware. In some cases, the name of the unit should not be considered as the restriction over the unit per se. For example, a first obtaining unit also may be described as “a unit for obtaining at least two Internet protocol addresses”.

The functionality described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

In the context of the present disclosure, machine readable medium may be tangible medium that may include or store programs for use by or in connection with instruction execution systems, apparatuses or devices. The machine readable medium may be machine readable signal medium or machine readable storage medium. The machine readable storage medium for example may include, but not limited to, electric, magnetic, optical, electromagnetic, infrared or semiconductor systems, apparatus or devices or any combinations thereof. Specific examples of the machine readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof.

Embodiments of the present disclosure also provide a computer program product comprising computer programs, wherein the computer programs, when executed by a processor, implements the method for updating the application method provided by any one embodiment of the present disclosure.

In the implementation of the computer program product, computer program instructions for executing operations of the present disclosure may be written in one or more programming languages or combinations thereof. The above programming languages include, but not limited to, object-oriented programming languages, e.g., Java, Smalltalk, C++ and so on, and traditional procedural programming languages, such as “C” language or similar programming languages. The program codes can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider).

In accordance with one or more embodiments of the present disclosure, Example 1 provides a method for updating an application method, the method comprising:
in response to a preconfigured method tracing function is executed, obtaining a method name of a target tracing method and modifying an execution entry of the target tracing method to a tracing execution entry under a method tracing mechanism;
based on the method tracing mechanism, calling a preconfigured method interceptor in accordance with the method name and executing a target updating method in the method interceptor, to implement update of an application method.

In accordance with one or more embodiments of the present disclosure, Example 2 provides a method for updating an application method, wherein the method further comprises:

In some optional implementations, the method, after obtaining a method name of a target tracing method, further comprises:
adding the method name into a list of methods to be traced.

In accordance with one or more embodiments of the present disclosure, Example 3 provides a method for updating an application method, comprising:

In some optional implementations, the calling a preconfigured method interceptor in accordance with the method name includes:
determining whether a function name of a function to be executed obtained under the method tracing mechanism is in the list of methods to be traced;
when the function name is in the list of methods to be traced, calling a method interceptor matching the function name.

In accordance with one or more embodiments of the present disclosure, Example 4 provides a method for updating an application method, further comprising:

In some optional implementations, a process of preconfiguring the method tracing function includes:
starting a function at Java layer through a preset method tracing mechanism and determining a tracing object, to enable a method tracing mechanism of a preset virtual machine;
Hooking an original function execution entry, an original function exit path and/or an original function backtracing path associated with the tracing object to a corresponding preset execution proxy entry, a corresponding preset exit proxy path and/or a corresponding preset backtracing proxy path.

In accordance with one or more embodiments of the present disclosure, Example 5 provides a method for updating an application method, further comprising:

In some optional implementations, the starting a function at Java layer through a preset method tracing mechanism and determining a tracing object, to enable a method tracing mechanism of a preset virtual machine includes:
creating and registering an Instrumentation listener as the tracing object;
setting entries of methods of all classes in the Java layer as tracing execution entries through an enable method tracing function in Instrumentation.

In accordance with one or more embodiments of the present disclosure, Example 6 provides a method for updating an application method, further comprising:

In some optional implementations, a process of preconfiguring the method tracing function also includes:

Hooking the enable method tracing method as a preset enable method tracing proxy function;
wherein the preset enable method tracing proxy function is empty.

In accordance with one or more embodiments of the present disclosure, Example 7 provides a method for updating an application method, further comprising:

In some optional implementations, the calling a preconfigured method interceptor in accordance with the method name includes:
calling a preconfigured method interceptor matching the method name through the preset execution proxy entry, the preset exit proxy path and/or the preset backtracing proxy path based on a Java local interface.

In accordance with one or more embodiments of the present disclosure, Example 8 provides a method for updating an application method, further comprising:

In some optional implementations, the obtaining a method name of the target tracing method also includes:
in response to any one Java method is executed, determining whether the any one Java method is provided with a listener;
in response to the any one Java method is provided with a listener, taking the any one Java method as a target tracing method and obtaining a method name of a target tracing method.

In accordance with one or more embodiments of the present disclosure, Example 9 provides an apparatus for updating an application method, comprising:
a method execution entry changing module for when a preconfigured method tracing function is executed, obtaining a method name of a target tracing method and modifying an execution entry of the target tracing method to a tracing execution entry under a method tracing mechanism;
a method interception and updating module for based on the method tracing mechanism, calling a preconfigured method interceptor in accordance with the method name and executing a target update method in the method interceptor, to implement update of an application method.

In accordance with one or more embodiments of the present disclosure, Example 10 provides an apparatus for updating an application method, further comprising:

In one optional implementation, the method execution entry changing module is also used for:
after obtaining a method name of a target tracing method, adding the method name into a list of methods to be traced.

In accordance with one or more embodiments of the present disclosure, Example 11 provides an apparatus for updating an application method, further comprising:

In one optional implementation, the method interception and update module is specifically for:
determining whether a function name of a function to be executed obtained under the method tracing mechanism is in the list of methods to be traced;
in response to the function name is in the list of methods to be traced, calling a method interceptor matching the function name.

In accordance with one or more embodiments of the present disclosure, Example 12 provides an apparatus for updating an application method, further comprising:

In one optional implementation, the apparatus for updating the application method also comprises a method tracing function configuration module for:
starting a function at Java layer through a preset method tracing mechanism and determining a tracing object, to enable a method tracing mechanism of a preset virtual machine;
Hooking an original function execution entry, an original function exit path and/or an original function backtracing path associated with the tracing object to a corresponding preset execution proxy entry, a corresponding preset exit proxy path and/or a corresponding preset backtracing proxy path.

In accordance with one or more embodiments of the present disclosure, Example 13 provides an apparatus for updating an application method, further comprising:

In one optional implementation, the method tracing function configuration module is further used for:
creating and registering an Instrumentation listener as the tracing object;
setting entries of methods of all classes in Java layer as tracing execution entries through an enable method tracing function in Instrumentation.

In accordance with one or more embodiments of the present disclosure, Example 14 provides an apparatus for updating an application method, further comprising:

In one optional implementation, the method tracing function configuration module is further used for:

Hooking the enable method tracing method as a preset enable method tracing proxy function;
wherein the preset enable method tracing proxy function is empty.

In accordance with one or more embodiments of the present disclosure, Example 15 provides an apparatus for updating an application method, further comprising:

In one optional implementation, the method interception and update module is also used for:
calling a preconfigured method interceptor matching the method name through the preset execution proxy entry, the preset exit proxy path and/or the preset backtracing proxy path based on a Java local interface.

In accordance with one or more embodiments of the present disclosure, Example 16 provides an apparatus for updating an application method, further comprising:

In one optional implementation, the method execution entry changing module is also used for:
when any one Java method is executed, determining whether the any one Java method is provided with a listener;
when the any one Java method is provided with a listener, taking the any one Java method as a target tracing method and obtaining a method name of a target tracing method.

The above description only explains the preferred embodiments of the present disclosure and the technical principles applied. Those skilled in the art should understand that the scope of the present disclosure is not limited to the technical solution resulted from particular combinations of the above technical features, and meanwhile should also encompass other technical solutions formed from any combinations of the above technical features or equivalent features without deviating from the above disclosed inventive concept, such as the technical solutions formed by substituting the above features with the technical features disclosed here with similar functions.

Furthermore, although the respective operations are depicted in a particular order, it should be appreciated that the operations are not required to be completed in the particular order or in succession. In some cases, multitasking or multiprocessing is also beneficial. Likewise, although the above discussion comprises some particular implementation details, they should not be interpreted as limitations over the scope of the present disclosure. Some features described separately in the context of the embodiments of the description can also be integrated and implemented in a single embodiment. Conversely, all kinds of features described in the context of a single embodiment can also be separately implemented in multiple embodiments or any suitable sub-combinations.

Although the subject matter is already described by languages specific to structural features and/or method logic acts, it is to be appreciated that the subject matter defined in the attached claims is not limited to the above described particular features or acts. On the contrary, the above described particular features and acts are only example forms for implementing the claims.

I/We claim:

1. A method for updating an application method comprising:
in response to a preconfigured method tracing function being executed, obtaining a method name of a target tracing method and modifying an execution entry of the target tracing method to a tracing execution entry under a method tracing mechanism; and
based on the method tracing mechanism, calling a preconfigured method interceptor in accordance with the method name and executing a target updating method in the method interceptor, to implement update of an application method.

2. The method of claim 1, wherein the method, after obtaining a method name of a target tracing method, further comprises:
adding the method name into a list of methods to be traced.

3. The method of claim 2, wherein calling a preconfigured method interceptor in accordance with the method name comprises:
determining whether a function name of a function to be executed obtained under the method tracing mechanism is in the list of methods to be traced; and
in response to the function name being in the list of methods to be traced, calling a method interceptor matching the function name.

4. The method of claim 1, wherein a process of preconfiguring the method tracing function comprises:
starting a function at Java layer through a preset method tracing mechanism and determining a tracing object, to enable a method tracing mechanism of a preset virtual machine; and
hooking an original function execution entry, an original function exit path and/or an original function backtracing path associated with the tracing object to a corresponding preset execution proxy entry, a corresponding preset exit proxy path and/or a corresponding preset backtracing proxy path.

5. The method of claim 4, wherein starting a function at Java layer through a preset method tracing mechanism and determining a tracing object, to enable a method tracing mechanism of a preset virtual machine comprises:
creating and registering an instrumentation listener as the tracing object; and
setting entries of methods of all classes in Java layer as tracing execution entries through an enable method tracing function in instrumentation.

6. The method of claim 5, wherein a process of preconfiguring the method tracing function further comprises:
hooking the enable method tracing method as a preset enable method tracing proxy function;
wherein the preset enable method tracing proxy function is empty.

7. The method of claim 4, wherein calling a preconfigured method interceptor in accordance with the method name comprises:
calling a preconfigured method interceptor matching the method name through the preset execution proxy entry, the preset exit proxy path and/or the preset backtracing proxy path based on a Java local interface.

8. The method of claim 1, wherein obtaining a method name of the target tracing method further comprises:
in response to any one Java method being executed, determining whether the any one Java method is provided with a listener;
in response to the any one Java method being provided with a listener, taking the any one Java method as a target tracing method and obtaining a method name of the target tracing method.

9. An electronic device comprising:
one or more processors;
a storage for storing one or more programs;
when the one or more programs are executed by the one or more processors, the one or more processors are caused to:
in response to a preconfigured method tracing function being executed, obtain a method name of a target tracing method and modify an execution entry of the target tracing method to a tracing execution entry under a method tracing mechanism; and
based on the method tracing mechanism, call a preconfigured method interceptor in accordance with the method name and execute a target updating method in the method interceptor, to implement update of an application method.

10. The electronic device of claim 9, wherein after obtaining a method name of a target tracing method, the one or more processors are further caused to:
add the method name into a list of methods to be traced.

11. The electronic device of claim 10, wherein calling a preconfigured method interceptor in accordance with the method name comprises:
determining whether a function name of a function to be executed obtained under the method tracing mechanism is in the list of methods to be traced; and
in response to the function name being in the list of methods to be traced, calling a method interceptor matching the function name.

12. The electronic device of claim 9, wherein a process of preconfiguring the method tracing function comprises:
starting a function at Java layer through a preset method tracing mechanism and determining a tracing object, to enable a method tracing mechanism of a preset virtual machine; and
hooking an original function execution entry, an original function exit path and/or an original function backtracing path associated with the tracing object to a corresponding preset execution proxy entry, a corresponding preset exit proxy path and/or a corresponding preset backtracing proxy path.

13. The electronic device of claim 12, wherein starting a function at Java layer through a preset method tracing mechanism and determining a tracing object, to enable a method tracing mechanism of a preset virtual machine comprises:
creating and registering an instrumentation listener as the tracing object; and
setting entries of methods of all classes in Java layer as tracing execution entries through an enable method tracing function in instrumentation.

14. The electronic device of claim 13, wherein a process of preconfiguring the method tracing function further comprises:
hooking the enable method tracing method as a preset enable method tracing proxy function;
wherein the preset enable method tracing proxy function is empty.

15. The electronic device of claim 12, wherein calling a preconfigured method interceptor in accordance with the method name comprises:
calling a preconfigured method interceptor matching the method name through the preset execution proxy entry, the preset exit proxy path and/or the preset backtracing proxy path based on a Java local interface.

16. The electronic device of claim 9, wherein obtaining a method name of the target tracing method further comprises:
in response to any one Java method being executed, determining whether the any one Java method is provided with a listener;
in response to the any one Java method being provided with a listener, taking the any one Java method as a target tracing method and obtaining a method name of the target tracing method.

17. A non-transitory computer readable storage medium having stored thereon computer programs which, when executed by a processor, cause the processor to:
in response to a preconfigured method tracing function being executed, obtain a method name of a target tracing method and modify an execution entry of the target tracing method to a tracing execution entry under a method tracing mechanism; and
based on the method tracing mechanism, call a preconfigured method interceptor in accordance with the method name and execute a target updating method in the method interceptor, to implement update of an application method.

18. The non-transitory computer readable storage medium of claim 17, wherein after obtaining a method name of a target tracing method, the computer programs further cause the processor to:
add the method name into a list of methods to be traced.

19. The non-transitory computer readable storage medium of claim 18, wherein calling a preconfigured method interceptor in accordance with the method name comprises:
determining whether a function name of a function to be executed obtained under the method tracing mechanism is in the list of methods to be traced; and
in response to the function name being in the list of methods to be traced, calling a method interceptor matching the function name.

20. The non-transitory computer readable storage medium of claim 17, wherein a process of preconfiguring the method tracing function comprises:
starting a function at Java layer through a preset method tracing mechanism and determining a tracing object, to enable a method tracing mechanism of a preset virtual machine; and
hooking an original function execution entry, an original function exit path and/or an original function backtracing path associated with the tracing object to a corresponding preset execution proxy entry, a corresponding preset exit proxy path and/or a corresponding preset backtracing proxy path.
